(19) United States
(12) Patent Application Publication
(10) Pub. No.: US 2006/0053060 A1
(43) Pub. Date: Mar. 9, 2006

(54) Business method for influencing consumer purchase of retail sales items

(76) Inventor: Kenneth S. Wyker, Charlotte, NC (US)

Correspondence Address: SCHWARTZ LAW FIRM, P.C., 6100 FAIRVIEW ROAD, SUITE 530, CHARLOTTE, NC, 28210, US

(21) Appl. No.: 11/242,268

(22) Filed: Oct. 3, 2005

Related U.S. Application Data
(63) Continuation of application No. 09/777,212, filed on Feb. 5, 2001.

(51) Int. Cl. G06Q 30/00

(52) U.S. Cl. 705/14

(57) ABSTRACT

A business method for influencing consumer purchase of retail sales items. An electronic consumer database is created for a plurality of retail stores. The database indicates a purchase history of items purchased by consumers at the retail stores. It is then determined when a common item is offered for sale by each of the retail stores at a reduced retail sales price. The reduced retail sales price is effective for a promotion period determined by the individual retail store. Based on the promotion periods for the common item at respective retail stores and the purchase history of the consumers, the common item or a complementary item is offered to a predetermined select group of consumers with a price discount established by a manufacturer of the common item. The manufacturer price discount results in a target sales price adapted to influence purchase by the consumer.

### TECHNICAL FIELD AND BACKGROUND OF THE INVENTION

This invention relates to a business method for influencing consumer purchase of retail sales items. The invention has particular application to manufacturers and retail grocery stores in the consumer packaged goods industry. The term “retail store” refers to a single company or franchise which purchases items from one or more manufacturers for resale to consumers. The term “manufacturer” refers to the company or franchise which manufactures items sold at the retail stores. Where a retail store manufactures and sells its own brand items, the terms manufacturer and retail store may refer to the same company or franchise.

To promote a packaged goods item, manufacturers typically budget for advertising, consumer promotion, and trade promotion. Trade promotion spending is allocated for use by the sales department to negotiate with the retail store for pricing and/or merchandising performance. Through the use of “trade money”, manufacturers achieve price reductions at retail stores during their trade promotion periods. They also generate merchandising support to increase consumer awareness of the reduced retail prices. The timing and depth of the price reduction varies by retail store. In conjunction with the trade promotion, the manufacturer's marketing department will typically implement some kind of consumer incentive to also generate awareness and interest in the product to drive sales. The consumer incentive often has a coupon element that provides savings to the consumer. Manufacturers and retail stores recognize the value of combining these two efforts more closely, but there are serious obstacles to be addressed.

Because manufacturers cannot demand specific pricing from retail stores, present manufacturer couponing programs are structured around providing a specific discount amount and they are unable to achieve a price-certain target sales price. The term “target sales price” refers to either a predetermined discounted price, or the effective discounted price after application of a manufacturer's coupon/discount. By contrast, retail stores can and do control the price offered to the consumer and therefore they typically communicate the net price, not just the amount of the price reduction. Moreover, manufacturer couponing programs generally run on a specific date or during a fixed time period, whereas retail price reductions at various stores generally occur at different times due to varied timing of retail pricing weeks and that retail stores do not want to be promoting an item at the same time as their competitors.

One unique element that makes the invention so compelling is the linkage of manufacturer couponing/discount programs with retail stores' existing promotional plans achieved through use of manufacturer trade money. No existing program offers manufacturers such control over their marketing efforts. Also, no other program takes advantage of the trade promotion activities to provide the maximum value to consumers while minimizing incremental consumer promotion costs.

The invention offers several benefits resulting from the synergistic linkage of a manufacturer's consumer promotion and trade promotion activities. According to the invention, the purchase incentive for consumers is increased by providing a personalized list of items targeted towards individual consumers using purchase history information contained in an electronic database. The object is to make shopping/saving easier and more convenient for the consumer. The invention further allows manufacturers to control and strategically allocate their couponing/discount efforts in a manner which maximizes returns. For example, most manufacturer coupon programs offer a standard four week cycle or other specific timing for each market. The invention allows the manufacturer to determine offer timing relative to each retail store's price reduction timing—either before, during, or after the retail price reduction depending upon the specific objectives of the manufacturers. In one case, a manufacturer may want to provide a coupon to heavy users of an item in weeks after a retail price reduction. This would offer the consumer a continued purchase incentive extending over the limited duration of the retail price reduction and the coupon period following. In another case, the manufacturer may want to target competitive brand buyers with a discount/coupon while the item is being promoted at the retail store in order to reach an extra low price.

The present invention promotes manufacturer coupon efficiency/synergy with its trade spending. A manufacturer can set up a coupon to run concurrent with a retail price reduction to reach a lower price for the consumer. These “piggyback” coupons generate impulse purchases because the consumer must act quickly to take advantage of both deals—the coupon and price reduction. The offers are also motivating because the net price to the consumer is lower than they will see advertised to the public.

The invention also provides “dead-net” pricing. Because manufacturers cannot set retail pricing, exact retail prices generally vary by retail store. Typical coupon opportunities available to manufacturers are structured to generate a specific savings for the consumer, e.g., $1.00 off. The invention uniquely allows manufacturers to offer targeted consumers a specific net price. Since the retail price reduction is known, the coupon value is adjusted accordingly to provide the consumer with the targeted net price.

The invention is adapted to create a more powerful incentive for consumer purchase by manipulating the two efforts—consumer promotion coupons and trade promotion price reduction—to stimulate consumer purchase. The manufacturer coupon/discount amount is repackaged in consideration of the existing consumer incentive created by the manufacturer trade spending efforts (retail price reduction).

### SUMMARY OF THE INVENTION

Therefore, it is an object of the invention to provide a business method which influences consumer purchase of retail sales items.

It is another object of the invention to provide a business method which gives the consumer a laser/thermal printed sheet of personalized messages and offers at the entrance of the retail store.

It is another object of the invention to provide a business method wherein offers to consumers are personalized based on prior purchase history at the retail store using frequent shopper data.

It is another object of the invention to provide a business method which utilizes a frequent shopper card which consumers scan at the retail store to trigger a printout of their personalized saving sheet. The use of consumer shopper cards is described in U.S. Pat. No. 5,857,175 issued to Micro Enhancement International. The complete disclosure of this patent is incorporated herein by reference.

It is another object of the invention to provide a business method which utilizes a frequent shopper card that identifies the consumer and triggers proper discounts at the register.

It is another object of the invention to provide a business method wherein the personalized saving sheet includes a listing of top discounted items that the consumer usually buys.

It is another object of the invention to provide a business method wherein offer timing is adjusted by retail store to synergistically work with existing manufacturer trade efforts.

It is another object of the invention to provide a business method which utilizes in-house support for each retail store.

It is another object of the invention to provide a business method which allows manufacturers to implement strategic couponing.

It is another object of the invention to provide a business method wherein manufacturer coupons are cleared electronically at the store register.

It is another object of the invention to provide a business method wherein a consumer's personalized saving sheet can be accessed via the Internet to view offers prior to entering the retail store.

It is another object of the invention to provide a business method which gives consumers the option to have their offers e-mailed to them each week.

These and other objects of the present invention are achieved in the preferred embodiments disclosed below by providing a business method for influencing consumer purchase of retail sales items. An electronic consumer database is created for each of a plurality of retail stores. The database indicates a purchase history of items purchased by consumers at the retail stores. It is then determined when a common item is offered for sale by each of the retail stores at a reduced retail sales price. The reduced retail sales price is effective for a promotion period determined by each retail store. Based on the promotion periods for the common item at respective retail stores and the purchase history of the consumers, the common item or a complementary item is offered to a predetermined select group of consumers with a price discount established by a manufacturer of the common item or complementary item. The manufacturer price discount results in a target sales price adapted to influence purchase by the consumer.

According to another preferred embodiment of the invention, the manufacturer's price discount is offered during the promotion period for the item such that the target sales price for the item is less than the reduced retail sales price.

According to another preferred embodiment of the invention, the manufacturer's price discount is offered prior to the promotion period in order to provide a discount for multiple purchases, or to provide continued incentive to purchase outside of the promotion period.

According to another preferred embodiment of the invention, a personalized saving sheet is provided to each consumer of the select group of consumers indicating the target sales price of the item.

According to another preferred embodiment of the invention, the personalized saving sheet indicates a total savings to the consumer when purchasing the item at the retail store.

According to another preferred embodiment of the invention, the personalized saving sheet is sent electronically to the consumer prior to the consumer entering the retail store.

According to another preferred embodiment of the invention, the personalized saving sheet is presented to the consumer at the retail store.

According to another preferred embodiment of the invention, the item is sold for the target sales price only when purchased in quantities of two or more.

According to another preferred embodiment of the invention, the item is offered for sale at the target sales price for only one day of the promotion period.

According to another preferred embodiment of the invention, the item is one that the consumer has a history of purchasing at the retail store.

According to another preferred embodiment of the invention, the item is one that the consumer has no history of purchasing at the retail store.

According to another preferred embodiment of the invention, the target sales price is automatically applied to the item at a point of sale.

In another embodiment, the invention includes purchasing an item from a manufacturer for resale at a retail store. A retail sales price is then established for the item. The item is then promoted for sale at a reduced retail sales price. The reduced retail sales price is effective for a promotion period determined by the retail store. During the promotion period, the item is offered to a predetermined select group of consumers at a price discount established by the manufacturer. The price discount is valid exclusively during all or part of the promotion period and results in a target sales price less than the reduced retail sales price.

In yet another embodiment, the invention includes selling an item to a plurality of retail stores for subsequent resale to consumers. Manufacturer trade funds are dispersed to the retail stores to promote the item for sale at reduced retail sales prices. The reduced retail sales prices are effective for a promotion period determined by each of the retail stores. A manufacturer price discount is then determined for the item sold by the retail stores to consumers. During the promotion period for each retail store, the manufacturer price discount is applied to the item for a predetermined select group of consumers thereby establishing a target sales price less than the reduced retail sales price of the item. The manufacturer price discount is valid at each of the retail stores exclusively during the promotion period for the individual retail store.

In yet another embodiment, the invention includes purchasing an item from a manufacturer for resale at a retail store. A retail sales price for the item is then established. The item is promoted for sale at a reduced retail sales price. The reduced retail sales price is effective for a promotion period determined by the retail store. During the promotion period, the item is offered to a predetermined select group of consumers at a price discount established by the manufacturer. The price discount is valid exclusively during all or part of the promotion period and results in a target sales price less than the reduced retail sales price. A personalized saving sheet is presented to each consumer of the select group of consumers indicating the target sales price of the item. The personalized saving sheet is presented to the consumer at the retail store.

In yet another embodiment, the invention includes selling an item to a plurality of retail stores for subsequent resale to consumers. Manufacturer trade funds are dispersed to the retail stores to promote the item for sale at reduced retail sales prices. The reduced retail sales prices are effective for a promotion period determined by each of the retail stores. A manufacturer price discount is determined for the item sold by the retail stores to consumers. During the promotion period for each retail store, the manufacturer price discount is applied to the item for a predetermined select group of consumers thereby establishing a target sales price less than the reduced retail sales price of the item. The manufacturer price discount is valid at each of the retail stores exclusively during all or part of the promotion period for the individual retail store. A personalized saving sheet is presented to each consumer of the select group of consumers indicating the target sales price of the item. The personalized saving sheet is presented to the consumer at the retail store.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a flow diagram illustrating operation of the present business method at one retail store; and

FIG. 2 is print out of a personalized saving sheet including items offered at reduced retail prices and/or with manufacturer discounts.

### DESCRIPTION OF THE PREFERRED EMBODIMENT AND BEST MODE

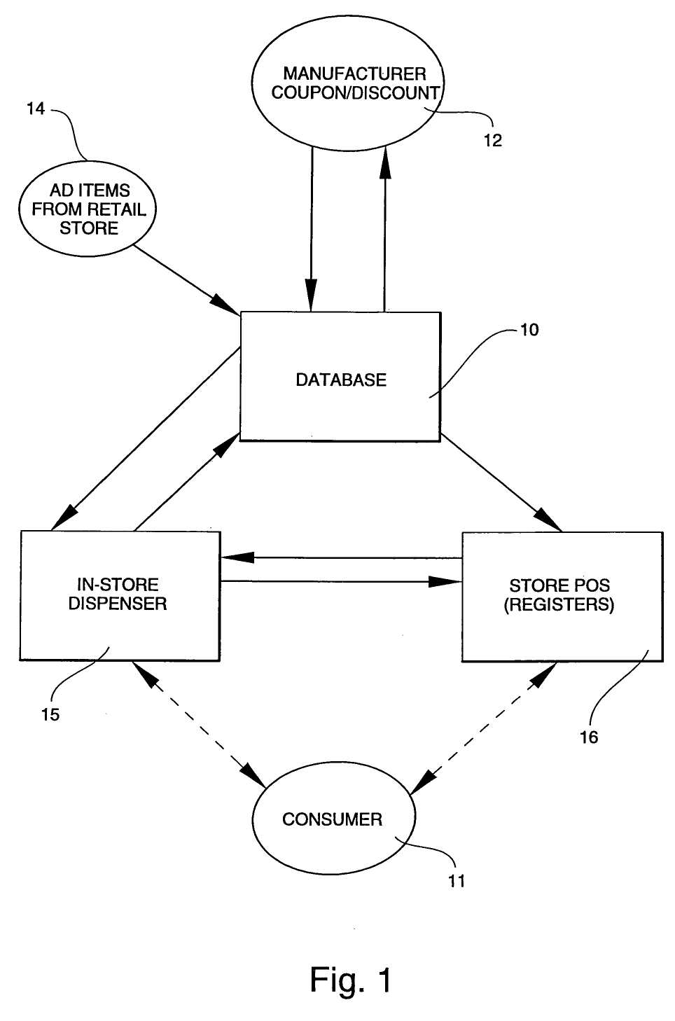

Referring now specifically to the drawings, a business method for influencing consumer purchase of retail sales items according to the present invention is illustrated in the flow diagram of FIG. 1. The business method utilizes an electronic database 10 populated using data from each of several participating retail stores, and computer-readable frequent shopper cards carried by consumers 11. The database 10 contains consumer information including purchase history and consumer segmentation. Using this database information and information including targeting criteria for manufacturer coupon/discount offers 12, and items advertised by the retail store 14, a targeted offer file is generated for each consumer 11. The offer file is downloaded to an in-store dispenser 15 and to the store registers 16 for point-of-sale application.

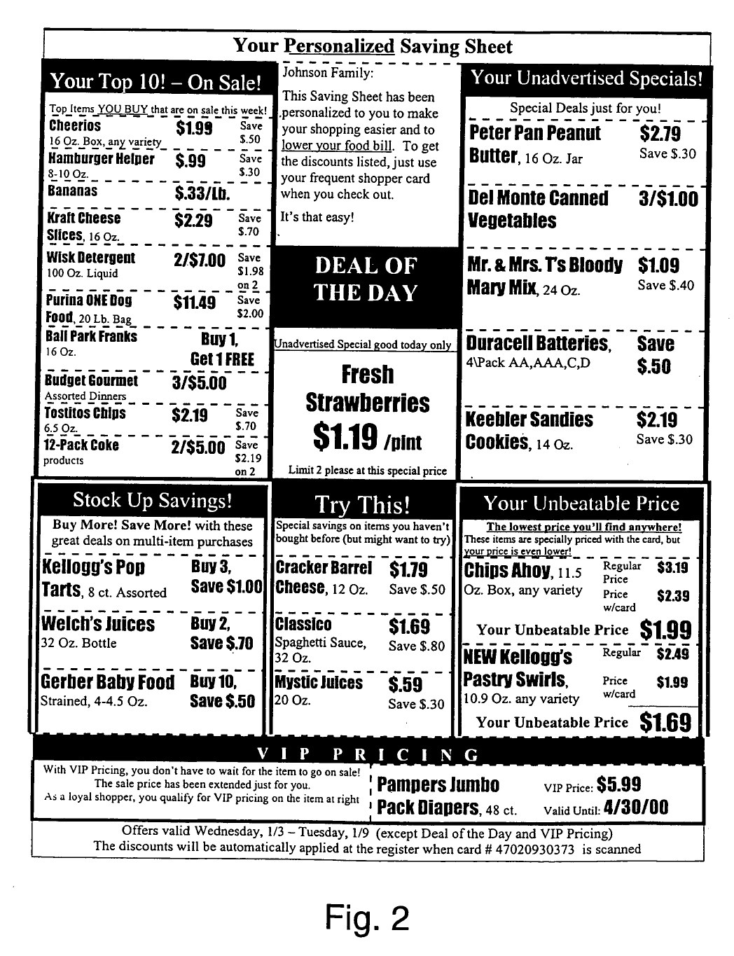

When a consumer 11 enters the retail store, he or she scans the frequent shopper card at the in-store dispenser 15 and receives a paper printout of a personalized saving sheet containing items in the targeted offer file. One example of a personalized saving sheet is shown in FIG. 2 and discussed further below. In an alternative embodiment, the personalized saving sheet is sent electronically to the consumer via e-mail. Scanning the shopper card at the in-store dispenser 15 triggers the store registers 16 to activate the offers provided to the consumer cardholder. The consumer 11 shops in the retail store using the personalized saving sheet and selecting those items which he or she chooses to purchase. When finished shopping, the consumer's frequent shopper card is scanned at the register and the selected items listed on the personalized saving sheet are automatically discounted at the point of sale. The store registers 16 return all consumer transaction and redemption data back to the in-store dispenser 15 which transfers the data to the database 10 for analysis. Using this updated data, a further target offer file is created for the consumer.

The personalized saving sheet, shown in FIG. 2, includes six main sections. The section titled “Your Top 10!—On Sale!” lists top items commonly purchased by the consumer and which are offered at a reduced sales price during a designated time period indicated on the saving sheet. The section titled “Your Unadvertised Specials” offers discounted prices and savings exclusively for the consumer cardholder. These offers may be for items currently between retail price reductions, or for those items which are frequently purchased by the consumer, or for any other items targeted to the particular consumer. The “Stock-Up Savings” section offers extra savings for multiple item purchases. The “Try This!” section offers special pricing on items which the consumer has no history of purchasing but may want to try. The section titled “Your Unbeatable Price” offers extra savings on certain items in addition to savings already provided by the retail store by way of a retail price reduction. The prices for these items are advertised as the lowest anywhere. The “Deal of the Day” section provides unadvertised specials for the consumer cardholder that are good that day only. The section titled “VIP Pricing” offers a manufacturer discounted price exclusively for select consumers who have a history of purchasing the discounted item. This discount price is offered outside of the retail store promotion period. The personalized saving sheet may also include other pages as necessary for a survey, recipes, sweepstakes, games, etc.

The selected items, offer timing, and discount amounts indicated on the personalized saving sheet are determined by the item manufacturers and the retail store. Manufacturers use trade money to negotiate retail price reductions for their items at retail stores, and coupon/discount programs offered directly to selected consumers for savings at the point of sale. The present business method allows manufactures to control and manipulate item cost by targeting their coupon/discount programs based on retail price reductions offered by retail stores. Since competing retail stores typically do not want to offer retail price reductions for a common item at the same time, the promotion periods for the common item are generally different from one retail store to the other. Manufacturer coupon/discount programs according to the present business method are therefore targeted to specific consumers at specific retail stores and during specific times. This allows the manufacturer to manipulate the cost of its item sold at competing retail stores in order to achieve certain goals for influencing consumer purchases. The examples below illustrate how this principle works.

In the following Examples 1, 2, and 3, manufacturer XYZ is promoting an item during the month of May. The trade deal offered by the manufacturer to retail stores in an effort to buy down the retail price of the item runs May 1-May 28. The trade deal is designed to generate a reduced retail price, the goal being $1.99 price point.

The manufacturer also wants to generate increased sales as follows:

| CONSUMER GROUP | OBJECTIVE |
|---|---|
| Existing consumer base | Increase purchase quantity or |
| | trade up to larger size |
| Brand switchers | Defend against competitive |
| | promotional activity. |
| | Reach consumer before |
| | competitor activity occurs |
| Infrequent buyers/light users | Stimulate purchase during |
| | seasonal usage period |
| Competitive brand users | Trial |

Examples 1, 2, and 3 are based on the following planned performance by retail Stores A, B and C:

| | Store A | Store B | Store C |
|---|---|---|---|
| Retail | $2.79 | $2.79 | $2.69 |
| Price | | | |
| Retail Price | $1.99 | $2.09 | 2/$4.00 |
| Reduction | | | |
| Promotion | 5/3-5/16 | 5/10-5/23 | 5/3-5/30 |
| Period | | | |

Strategic objectives of the manufacturer are communicated to database managers which may be located on-site at each participating retail store. The promotion specifics for each retail store are determined based on these objectives and the established timing and pricing of the retail activity.

### EXAMPLE 1

Target: Competitive users
Objective: Trial
Offer: $1.69 net price

Timing: During promotion period

| | Store A | Store B | Store C |
|---|---|---|---|
| Manufacturer | $.30 | $.40 | $.31 |
| Discount | | | |
| Timing | 5/3-5/16 | 5/10-5/23 | 5/3-5/30 |

In this example, additional savings are added by the manufacturer of the item to reach the desired consumer incentive at each of the retail Stores A, B, and C. The lower net price achieved using the manufacturer discount provides substantial purchase incentive for consumers who would otherwise normally purchase a competing item. The manufacturer discount is targeted only to a select group of consumers based on consumer information and purchase history contained in the retail store database. The amount and timing of the manufacturer discount is dependant upon the reduced retail sales price at each of the stores and the timing of the promotion periods. The synergistic combination of these events enables the manufacturer to efficiently and effectively reach its desired objective. If the promotion were not combined with the retail price reduction, the cost to the manufacturer would be significantly higher. To achieve the targeted sales price of $1.69 requires a coupon discount of $0.30-$0.40. However, if the same incentive were offered during a time the item was not being promoted, the cost of the discount to the manufacturer would be $1.00-$1.10.

### EXAMPLE 2

Target: Current user base
Objective: Increase purchases (stock-up)
Offer: Buy 3 for only $5.00 (must buy 3)

Timing: During deal

| | Store A | Store B | Store C |
|---|---|---|---|
| Purchase | 3 units | 3 units | 3 units |
| required | | | |
| Discount | $.97 | $1.27 | $1.00 |
| Timing | 5/3-5/16 | 5/10-5/23 | 5/3-5/30 |

In this example, the manufacturer's objective is to create increased purchases by offering the item for an effective target sales price of $1.67 provided the consumer purchases three of the items. The manufacturer discount runs only during the promotion period at each of the retail Stores A, B, and C. Consequently, the manufacturer reaches its target sales price when the item is being offered by each of the retail stores at respective reduced retail prices.

### EXAMPLE 3

Target: Switchers
Objective: Reach prior to competitive deals, move multiple units
Offer: 2nd Item Half Price

Timing: Month prior to deal

| | Store A | Store B | Store C |
|---|---|---|---|
| Purchase | 2 units | 2 units | 2 units |
| required | | | |
| Discount | $1.39 | $1.39 | $1.34 |
| Timing | 4/5-5/2 | 4/12-5/9 | 4/5-5/2 |

In this example, the manufacturer price discount is applied to the item one month prior to the promotion periods at the retail stores. The timing flexibility and the ability to adapt to the retail store's pricing provides the manufacturer an opportunity to create efficient incentives for consumers. Example 3 demonstrates how this might be applied to get switchers to purchase multiple items before the promotion periods begin. A motivating offer of “Buy 1, get 2nd half price” can be implemented when the item is at full retail prior to the retail price reduction. Also, by offering the manufacturer discount at a time between promotion periods, loyal consumers who regularly purchase the item can be rewarded with a discounted price over a greater time period.

In other applications of the present business method, the manufacturer may offer a price discount to a select group of consumers for an item complementary to one which is presently being promoted by the retail store at a reduced retail sales price. For example, during a retail store's promotion period for lettuce, a manufacturer may choose to offer a discount on salad dressing or plastic storage bags or sandwich bread. In another application, during the retail promotion period for a leading brand item, a manufacturer may target store-brand buyers during this period with an offer to ensure savings, e.g. 10% off of the leading brand item price, when the consumer purchases the store brand. In yet another application, the manufacturer may offer an incentive for a minimum dollar purchase of its brand. For example, when KRAFT cheese, macaroni & cheese, and salad dressing are not being offered at reduced retail prices, the manufacturer may offer 10% off all KRAFT products with a minimum purchase of $5 in KRAFT products.

A business method for influencing consumer purchase of retail sales items is described above. Various details of the invention may be changed without departing from its scope. Furthermore, the foregoing description of the preferred embodiment of the invention and the best mode of practicing the invention are provided for the purpose of illustration only and not for the purpose of limitation—the invention being defined by the claims.

1-20. (canceled)

21. A business method utilized by a manufacturer of retail sales items for strategically manipulating timing of manufacturer incentives to effect a net retail sales price of the retail sales items supplied by the manufacturer to a plurality of retail stores and offered at the retail stores for sale to consumers, said method comprising the steps of:
(a) creating an electronic consumer database for each of the plurality of retail stores, the database indicating a purchase history of items purchased by consumers at the retail store;
(b) determining when a common item is offered for sale by each of the retail stores at a reduced retail sales price, the reduced retail sales price being effective for a promotion period determined by each retail store;
(c) considering the promotion periods for the common item at respective retail stores and the purchase history of the consumers; and
(d) after step (c) and based on the promotion periods for the common item at respective retail stores and the purchase history of the consumers, the manufacturer offering a manufacturer incentive to a predetermined select group of consumers for purchase of the common item at at least one of the retail stores, the manufacturer incentive coordinating with the reduced retail sales price offered by the retail store to reach a manufacturer-influenced targeted sales price adapted to influence purchase by the consumer.

22. A business method according to claim 21, wherein the manufacturer incentive is offered at each of the retail stores exclusively during the promotion period for each retail store, such that the target sales price for the item is less than the reduced retail sales price.

23. A business method according to claim 21, wherein the manufacturer incentive is offered at each of the retail stores outside of the promotion period for each retail store.

24. A business method according to claim 21, and comprising providing a personalized saving sheet to each consumer of the select group of consumers indicating the target sales price of the item.

25. A business method according to claim 24, wherein the personalized saving sheet indicates a total savings to the consumer when purchasing the item at the retail store.

26. A business method according to claim 24, and comprising electronically sending the personalized saving sheet to the consumer prior to the consumer entering the retail store.

27. A business method according to claim 24, and comprising presenting the personalized saving sheet to the consumer at the retail store.

28. A business method according to claim 21, wherein the item is sold for the target sales price only when purchased in quantities of two or more.

29. A business method according to claim 21, wherein the item is offered for sale at the target sales price for only one day of the promotion period.

30. A business method according to claim 21, wherein the item is one that the consumer has a history of purchasing at the retail store.

31. A business method according to claim 21, wherein the item is one that the consumer has no history of purchasing at the retail store.

32. A business method according to claim 21, and comprising automatically applying the target sales price to the item at a point of sale.

33. A business method utilized by a manufacturer of retail sales items for strategically manipulating timing of manufacturer incentives to effect a net retail sales price of the retail sales items supplied by the manufacturer to a plurality of retail stores and offered at the retail stores for sale to consumers, said method comprising the steps of:
(a) creating an electronic consumer database for each of the plurality of retail stores, the database indicating a purchase history of items purchased by consumers at the retail store;
(b) determining when a common item is offered for sale by each of the retail stores at a reduced retail sales price, the reduced retail sales price being effective for a promotion period determined by each retail store;
(c) considering the promotion periods for the common item at respective retail stores and the purchase history of the consumers; and
(d) after step (c) and based on the promotion periods for the common item at respective retail stores and the purchase history of the consumers, the manufacturer offering a manufacturer incentive to a predetermined select group of consumers for purchase of a complementary item at at least one of the retail stores, the manufacturer incentive coordinating with the reduced retail sales price offered by the retail store to reach a manufacturer-influenced targeted sales price adapted to influence purchase by the consumer.

34. A business method according to claim 33, wherein the manufacturer incentive is offered at each of the retail stores exclusively during the promotion period for each retail store.

35. A business method according to claim 33, wherein the complementary item is offered for sale at the target sales price for only one day of the promotion period.

36. A business method according to claim 33, wherein the complementary item is one that the consumer has a history of purchasing at the retail store.

37. A business method according to claim 33, wherein the complementary item is one that the consumer has no history of purchasing at the retail store.

38. A business method according to claim 33, and comprising automatically applying the target sales price to the complementary item at a point of sale.

39. A business method utilized by a manufacturer of retail sales items for strategically manipulating timing of manufacturer incentives to effect a net retail sales price of the retail sales items supplied by the manufacturer to a plurality of retail stores and offered at the retail stores for sale to consumers, said method comprising the steps of:
(a) creating an electronic consumer database for each of the plurality of retail stores, the database indicating a purchase history of items purchased by consumers at the retail store;
(b) determining when a common item is offered for sale by each of the retail stores at a reduced retail sales price, the reduced retail sales price being effective for a promotion period determined by each retail store;
(c) considering the promotion periods for the common item at respective retail stores and the purchase history of the consumers; and
(d) after step (c) and based on the promotion periods for the common item at respective retail stores and the purchase history of the consumers, the manufacturer offering a manufacturer incentive to a predetermined select group of consumers for purchase of the common item at at least one of the retail stores, the manufacturer incentive being valid only during the promotion period of the retail store, and the manufacturer incentive coordinating with the reduced retail sales price offered by the retail store to reach a manufacturer-influenced targeted sales price adapted to influence purchase by the consumer.

40. A business method according to claim 39, and comprising providing a personalized saving sheet to each consumer of the select group of consumers indicating the target sales price of the item.
